(19) United States
(12) Patent Application Publication
(10) Pub. No.: US 2026/0135184 A1
(43) Pub. Date: May 14, 2026

(54) COOLING FIN, BATTERY MODULE AND BATTERY MODULE ASSEMBLY INCLUDING SAME

(71) Applicants: SK INNOVATION CO., LTD., Seoul (KR); SK ENMOVE CO., LTD., Seoul (KR); SK On Co., Ltd., Seoul (KR)

(72) Inventors: Min Je PARK, Daejeon (KR); Seok Hwan LEE, Daejeon (KR)

(21) Appl. No.: 19/378,343

(22) Filed: Nov. 4, 2025

(30) Foreign Application Priority Data
Nov. 13, 2024 (KR) 10-2024-0161230

(51) Int. Cl. H01M 10/6551; F28F 3/12; H01M 10/613; H01M 10/647; H01M 10/6554; H01M 10/656; H01M 50/209

(52) U.S. Cl. CPC H01M 10/6551; F28F 3/12; H01M 10/613; H01M 10/647; H01M 10/6554; H01M 10/656; H01M 50/209

(57) ABSTRACT

Proposed is a cooling fin and a battery module using the cooling fin, the cooling fin including a cooling plate in which a cooling path is formed, and a support plate connected to each of upper and lower ends of the cooling plate, wherein the cooling plate comprises at least one cooling path configured to allow a cooling fluid to flow inside the cooling plate.

### CROSS REFERENCE TO RELATED APPLICATION

The present application claims priority to Korean Patent Application No. 10-2024-0161230, filed Nov. 13, 2024, the entire contents of which is incorporated herein for all purposes by this reference.

### BACKGROUND

### Technical Field

The embodiments of the present disclosure relate to a cooling fin, a battery module, and a battery module assembly including the same.

### Description of the Related Art

In recent years, as mobile devices such as mobile phones and laptops have become smaller and lighter, and electric vehicles and hybrid vehicles demand high-capacity power sources, a variety of batteries have been developed and are used.

In the case of secondary batteries, efficiency is becoming increasingly important depending on the application field, but problems such as heat generation and fires during charging or operation occur due to external factors.

Accordingly, technologies are being developed to increase the operating efficiency of secondary batteries and ensure safety. Moreover, a recent surge in electricity usage has led to increased carbon emissions and exacerbated global warming concerns, which has called for more efficient device operation mechanisms, and improved cooling methods and maximization of cooling efficiency therefor.

### SUMMARY

According to an embodiment of the present disclosure, provided is a cooling fin that enables efficient operation of a battery module and device by efficiently cooling the battery module.

In addition, provided are a battery module and a battery module assembly, in which cooling efficiency and reliability are improved by cooling the entire battery module along with cooling between battery cells using a cooling fin.

According to an embodiment of the present disclosure, there is provided a cooling fin including a cooling plate in which a cooling path is formed; and a support plate connected to each of upper and lower ends of the cooling plate, wherein the cooling plate may comprise at least one cooling path configured to allow a cooling fluid to flow inside the cooling plate.

In this case, the support plate may be provided in a flat shape parallel to upper and lower surfaces of the cooling plate.

In addition, the cooling path may be provided to penetrate opposite ends of the cooling plate, so that the cooling fluid may flow into a first end to flow inside the cooling plate and flow out from a second end.

According to an embodiment of the present disclosure, there is provided a battery module including a plurality of battery cells stacked in one direction; and a cooling fin coupled between stacked surfaces of the battery cells, wherein the cooling fin may include a cooling plate coupled between the stacked surfaces of the battery cells and in which a cooling path is formed; and a support plate configured to extend from each of upper and lower ends of the cooling plate and cover upper and lower surfaces of adjacent battery cells, wherein the cooling path may be formed to extend in one direction of the stacked surfaces of the battery cells, and to penetrate in a direction of first ends and second ends of the stacked surfaces of the battery cells.

In this case, the battery module may further include a buffer pad coupled between the stacked surfaces of the battery cells, wherein the buffer pad and the cooling fin may be alternately coupled between the stacked surfaces of the battery cells.

According to an embodiment of the present disclosure, there is provided a battery module assembly including a battery module including a plurality of battery cells stacked in one direction, and a cooling fin coupled between stacked surfaces of the battery cells, wherein the cooling fin may include a cooling plate coupled between the stacked surfaces of the battery cells and in which a cooling path is formed; and a support plate configured to extend from each of upper and lower ends of the cooling plate and cover upper and lower surfaces of adjacent battery cells, wherein the cooling path may be formed to extend in one direction of the stacked surfaces of the battery cells, and to penetrate in a direction of first ends and second ends of the stacked surfaces of the battery cells; and a casing configured to accommodate the battery module, wherein the casing may include an inlet portion through which a cooling fluid flows in on a first side thereof; and an outlet portion through which a cooling fluid is discharged on a second side thereof.

In this case, a movement direction of a cooling fluid from the inlet portion to the outlet portion of the casing and a direction from a first end to a second end of the cooling path of the cooling plate may be formed to be parallel.

In addition, a space between the inlet portion of the casing and a first end of the battery module accommodated in the casing, and a space between the outlet portion of the casing and a second end of the battery module accommodated in the casing may be configured to be filled with the cooling fluid.

In addition, the battery module assembly may further include a buffer pad coupled between the stacked surfaces of the battery cells, wherein the buffer pad and the cooling fin may be alternately coupled between the stacked surfaces of the battery cells.

According to another embodiment of the present disclosure, there is provided a cooling fin for a battery module including a cooling plate having a rectangular cross-section and including a plurality of cooling paths that are spaced apart from each other; a top support plate connected to an upper surface of the cooling plate; and a bottom support plate connected to a lower surface of the cooling plate,

wherein the cooling fin may have an I-beam shape in which the top and bottom support plates provide support for a first and a second battery cell of the battery module, and the cooling plate is configured to contact a stacking surface of each of the first and second battery cells,

and wherein the plurality of cooling paths are configured to allow a cooling fluid to flow inside the cooling plate to cool the battery module.

The features and advantages of the embodiments of the present disclosure will become more apparent from the following detailed description based on the accompanying drawings.

Terms or words used in this specification and claims should not be construed in their usual, dictionary meaning, and should be interpreted with meaning and concept consistent with the technical idea of the present disclosure based on the principle that the inventor can define terminology appropriately to describe an invention in the best way possible.

According an embodiment of the present disclosure, the cooling efficiency of secondary battery cell modules can be improved.

Furthermore, by allowing a cooling fluid to flow in the outer space including a battery module, the reliability and efficiency of cooling of a battery module assembly can be improved through overall cooling of the inside and outside of the battery module.

Furthermore, by maximizing the cooling efficiency of a battery module and increasing the energy efficiency of battery module cooling, power consumption can be reduced and carbon emissions from the operation of related devices can be reduced.

Furthermore, by blocking heat transfer between battery cells due to fire inside a battery module in advance, the risk of battery module explosion, etc., can be effectively reduced.

### BRIEF DESCRIPTION OF THE DRAWINGS

The above and other objectives, features, and other advantages of the embodiments of the present disclosure will be more clearly understood from the following detailed description when taken in conjunction with the accompanying drawings, in which:

FIG. 1 is a front view of a cooling fin according to an embodiment of the present disclosure;

FIG. 2 is a perspective view of a cooling fin according to an embodiment of the present disclosure;

FIG. 3 is a perspective view of a portion of a battery module according to an embodiment of the present disclosure;

FIG. 4 is a front view of a portion of a battery module according to an embodiment of the present disclosure; and

FIG. 5 is a perspective view of a battery module assembly according to an embodiment of the present disclosure.

### DETAILED DESCRIPTION

Terms used to describe an embodiment of the present disclosure are not intended to limit the scope of the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In the present disclosure, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

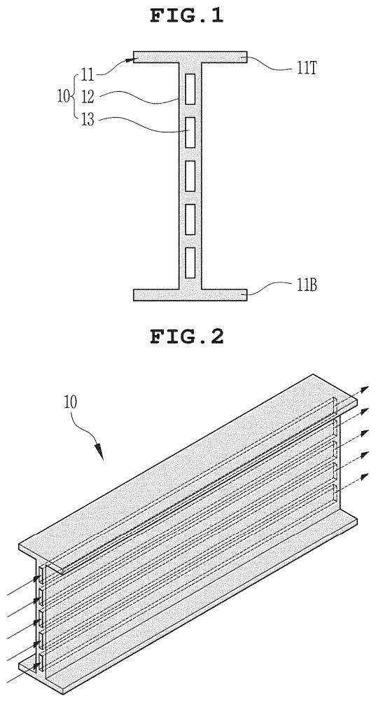

FIG. 1 is a front view of a cooling fin according to an embodiment of the present disclosure, and FIG. 2 is a perspective view of a cooling fin according to an embodiment of the present disclosure.

A cooling fin 10 according to an embodiment of the present disclosure may include a cooling plate 12 in which a cooling path 13 is formed, and a support plate 11 connected to each of the upper and lower ends of the cooling plate 12. The cooling plate 12 may comprise at least one cooling path 13 configured to allow a cooling fluid to flow inside the cooling plate 12. The cooling plate 12 as illustrated in FIG. 1 comprises a plurality (e.g., 5) cooling paths 13 which are spaced apart from each other.

As shown in FIG. 1, the cooling fin 10 may be provided with the cooling plate 12 in which the cooling paths 13 are formed, and the support plate 11 may be combined at the top and bottom of the cooling plate 12. The cooling plate 12 and the support plate 11 may be combined separately (i.e., separate pieces coupled together) or formed as one single integral piece. The overall shape of the cooling fin 10 may be the same of the capital English letter “I” or of an I-beam. The cooling plate 12 with the plurality of the spaced apart cooling paths 13 form the vertical part while the support plate 11 form the top and bottom horizontal parts. Hence, the support plate 11 may comprise a top support 11T and bottom support plate 11B.

When forming a battery module, the cooling plate 12 may be coupled between a first battery cell 20 and a second battery cell 20, and may be combined in surface contact with the stacked surface of the battery cell body 21 in a surface extending in one direction to cool the battery cells 20. The cooling plate 12 is disposed between two adjacent battery cells 20 and contacts the stacked surface of the battery cell body 21 of each of the battery cells 20 for cooling the battery cells 20. This configuration allows the cooling plate 12 to efficiently absorb and dissipate heat generated during battery operation. By maintaining direct surface contact along the extended stacking direction, thermal management is enhanced, helping to prevent overheating and improve overall module reliability.

At least one cooling path 13 may be formed on the cooling plate 12. When a plurality of cooling path 13 are formed, they may be spaced apart from each other. Since the size or number of the cooling paths 13 is not particularly limited, cooling paths 13 of different sizes may be formed. If necessary, a single cooling path 13 may be formed on the cooling plate 12.

The support plate 11 may be provided in a flat shape parallel to the upper and lower surfaces of the cooling plate 12. When the cooling plate 12 is coupled between battery cells 20, the support plate 11 may support and cover both sides of the upper and lower surfaces of the adjacent battery cells 20.

The support plate 11 may be formed integrally with the cooling plate 12, and may be made of a material having high thermal conductivity to perform the function of cooling the upper and lower surfaces of the battery cell 20 while covering the upper and lower surfaces of the battery cell 20.

As shown in FIG. 2, the cooling plate 12 may be configured such that the cooling path 13 passes through opposite ends thereof in order for a cooling fluid flowing inside the cooling plate 12 to flow in one end of the flow direction of the cooling fluid and flow out the other end of the flow direction of the cooling fluid.

That is, when the cooling plate 12 is combined so that battery cells 20 are in contact on opposite sides of the cooling plate 12, a cooling effect may occur at the surface where the cooling plate 12 and the battery cell body 21 come into contact by the cooling fluid flowing inside the cooling plate 12. The cooling plate 12 may be combined between battery cells 20 with a minimum volume while simultaneously covering the entire stacked surface of the battery cell body 21.

The cooling path 13 of the cooling plate 12 is formed to penetrate both longitudinal ends of the cooling plate 12, so that the cooling fluid can be continuously circulated, thereby increasing the cooling efficiency of battery cells 20.

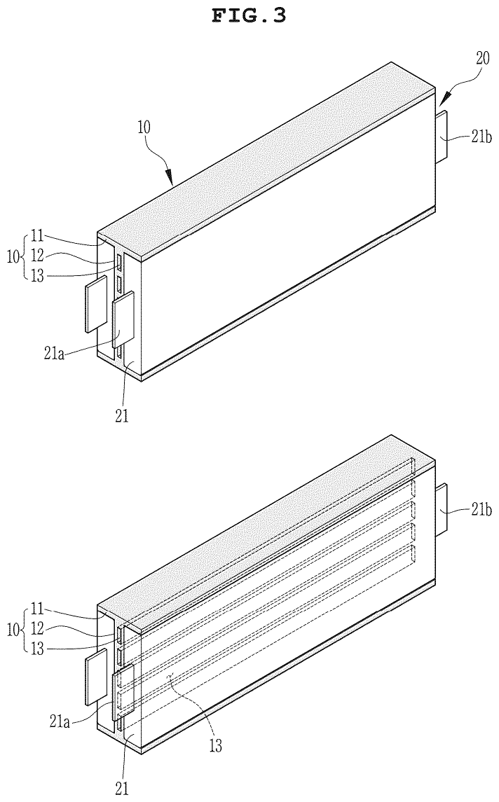

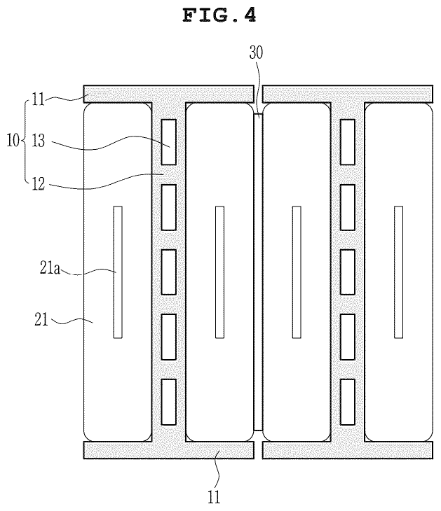

FIG. 3 is a perspective view of a portion of a battery module according to an embodiment of the present disclosure, and FIG. 4 is a front view of a portion of a battery module according to an embodiment of the present disclosure.

A battery module including a cooling fin 10 according to an embodiment of the present disclosure may include a plurality of battery cells 20 stacked in one direction, and the cooling fin 10 coupled between the stacked surfaces of the battery cells 20. The cooling fin 10 may include a cooling plate 12 coupled between the stacked surfaces of the battery cells 20 and in which a cooling path 13 is formed, and a support plate 11 provided to extend from the top and bottom of the cooling plate 12 and covering the upper and lower surfaces of the adjacent battery cells 20. The cooling path 13 is formed to extend in one direction of the stacked surface of the battery cells 20, and to penetrate in a direction of one end and the other end of the stacked surface of the battery cells 20.

The battery cell 20 may be provided with a first tab portion 21a and a second tab portion 21b at opposite ends, respectively, of the battery cell body 21. The first tab portion 21a and the second tab portion 21b may be formed with different polarities of the negative electrode and the positive electrode. However, the form of the tab joint of the battery cell 20 is not limited to the illustrated embodiment, and the formation positions of the first tab portion 21a and the second tab portion 21b may be designed and changed within a normal range. For example, both the first tab portion and the second tab portion may be formed at one end of the battery cell body 21.

In addition, the disclosed battery cell 20 includes a pouch-type secondary battery format, and may include various battery shapes such as cylindrical or square, and the cooling fin according to an embodiment of the present disclosure may be applied through appropriate structural changes according to each battery shape.

As shown in FIG. 3, when a plurality of battery cells 20 is stacked in one direction, the cooling fin 10 may be combined between the stacked surfaces of the battery cells 20.

The cooling fin 10 may include the cooling plate 12 coupled between the stacked surfaces of the battery cells 20, and the support plate 11 that covers each of the upper and lower surfaces of the battery cells 20 in opposite directions of the stacked surfaces.

As shown in the second drawing from the bottom in FIG. 3, the cooling plate 12 is combined with the stacked surfaces of the battery cell body 21, and may cool the battery cell 20 that is in contact with the cooling plate 12 by means of the cooling paths 13 in which a cooling fluid flows.

At least one cooling path 13 may be formed between the top and bottom of the cooling plate 12, and the size, arrangement, and number of cooling paths 13 may be appropriately designed and changed according to the battery module to which the cooling path 13 is applied.

Since the cooling fin 10 coupled to the battery module according to an embodiment of the present disclosure is substantially the same in configuration and function as the cooling fin 10 according to an embodiment of the present disclosure already described above, redundant description will be omitted.

As shown in FIG. 4, a buffer pad 30 is coupled between the stacked surfaces of the battery cells 20, and the buffer pad 30 and the cooling fin 10 may be alternately coupled between the stacked surfaces of the battery cells 20.

The buffer pad 30 may flexibly respond to expansion of the battery cell 20 of the battery module and the like, and effectively buffer pressure changes within the battery module. The buffer pad 30 may be coupled to the stacked surfaces between the battery cells 20, and the thickness and material of the buffer pad 30 may be varied as long as appropriate elasticity is provided. The buffer pad 30 is coupled with a predetermined thickness so that when one of the battery cells 20 expands due to overheating or other reasons, the reliability of the operation of the battery cell 20 may be stably secured through an appropriate buffering action.

In addition, by applying an insulating material, the buffer pad 30 may block heat transfer between battery cells 20 in advance. In this case, by preventing heat transfer and thermal runaway to an adjacent battery cell 20 due to an explosion or fire from one battery cell 20, the risk of fire in the entire battery module may be reduced or effectively prevented.

In addition, although not shown, the buffer pad 30 may be coupled to the stacked surfaces between the battery cells 20 separately from the cooling fin 10, but may also be coupled to one of the two sides of the cooling plate 12.

Alternatively, the cooling plate 12 may be manufactured and applied as an integral part including different materials by applying an insulating material to block heat transfer to one side of the cooling plate 12 and applying a material that facilitates heat transfer to the other side.

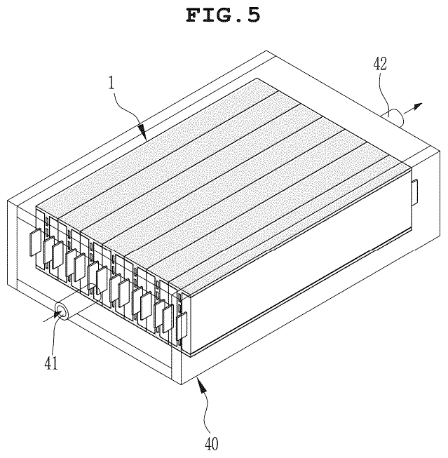

FIG. 5 is a perspective view of a battery module assembly according to an embodiment of the present disclosure.

A battery module assembly 1 according to an embodiment of the present disclosure may include a battery module including a plurality of battery cells 20 stacked in one direction and a cooling fin 10 coupled between the stacked surfaces of the battery cells 20. The cooling fin 10 may include a cooling plate 12 coupled between the stacked surfaces of the battery cells 20 and in which a cooling path 13 is formed, and a support plate 11 provided to extend from the top and bottom of the cooling plate 12 and covering the upper and lower surfaces of the adjacent battery cells 20. The cooling path 13 may be formed to extend in one direction of the stacked surface of the battery cells 20, and to penetrate in a direction of one end to the other end of the stacked surface of the battery cells 20. The assembly 1 may further include a casing 40 that accommodates the battery module, and the casing 40 may have an inlet portion 41 through which a cooling fluid flows in on one side thereof, and an outlet portion 42 through which a cooling fluid is discharged on the other side thereof.

The battery module may be formed by stacking and combining the plurality of battery cells 20 in one direction. The cooling fin 10 may be coupled between the stacked surfaces of the battery cells 20 to cool the battery cells 20. The cooling fin 10 may be coupled between the stacked surfaces of the battery cells 20, and one cooling fin 10 may be coupled to every two battery cells 20, so that the stacking thickness or cooling efficiency of the battery module may be appropriately adjusted. The cooling fin 10 may be coupled and applied between each stacked surface of the battery cells as needed.

The battery module assembly 1 according to an embodiment of the present disclosure may further include the casing 40 that accommodates the battery module.

The casing 40 accommodates the battery module, and may be provided with an inlet portion 41 through which a cooling fluid flows in and an outlet portion 42 through which a cooling fluid is discharged to the outside.

The movement direction of the cooling fluid from the inlet portion 41 to the outlet portion 42 of the casing 40 and the direction from one end to the other end of the cooling path 13 formed in the cooling plate 12 may be formed to be parallel or substantially parallel. Due to this, by allowing the cooling fluid flowing into the inlet portion 41 to naturally pass through the cooling path 13 of the cooling plate 12 coupled to the battery module, the flow of the cooling fluid may be induced more effectively, thereby increasing the cooling efficiency of the battery module. This parallel alignment minimizes flow resistance and ensures uniform heat dissipation across the battery cells.

By appropriately changing and adjusting the number or shape of the inlet portion 41, the amount or speed of the cooling fluid passing through the cooling path 13 formed in the cooling plate 12 may be controlled.

As shown in FIG. 5, a space between the inlet portion 41 of the casing 40 and one end of the battery module accommodated in the casing 40, and a space between the outlet portion 42 of the casing 40 and the other end of the battery module accommodated in the casing 40 may be maintained filled with the cooling fluid, so that the outer surfaces of the front and rear of the battery module may be cooled by direct cooling.

That is, since a bus bar included in the battery module assembly and the tab portions 21a and 21b of the battery cell 20 can all be directly cooled, the overall cooling effect of the battery module assembly may be maximized.

Since the cooling fin 10 and the battery module included in the battery module assembly 1 are substantially identical in configuration and function to the cooling fin 10 and battery module previously described in another embodiment of the present disclosure, a detailed description will be omitted to avoid redundancy.

Above, the embodiments of the present disclosure have been described in detail through specific embodiments. The embodiments are only illustrative and do not limit the scope of the appended claims. It should be understood by those skilled in the art that various changes and modifications to the embodiments are possible within the scope and technical concepts of the present disclosure, and such changes and modifications fall within the scope of the appended claims. Furthermore, the embodiments may be combined to form additional embodiments.

What is claimed is:

1. A cooling fin comprising:
a cooling plate including at least one cooling path; and
a support plate connected to each of an upper end and a lower end of the cooling plate,
wherein the at least one cooling path is configured to allow a cooling fluid to flow inside the cooling plate.

2. The cooling fin of claim 1, wherein the support plate has a flat shape and is parallel to upper and lower surfaces of the cooling plate.

3. The cooling fin of claim 1, wherein the cooling path is provided to penetrate opposite ends of the cooling plate, so that the cooling fluid flows into a first end to flow inside the cooling plate and flows out from a second end.

4. A battery module comprising:
a plurality of battery cells stacked in one direction; and
a cooling fin coupled between stacked surfaces of the battery cells,
wherein the cooling fin comprises:
a cooling plate coupled between the stacked surfaces of the battery cells and including a cooling path; and
a support plate configured to extend from each of upper and lower ends of the cooling plate and cover upper and lower surfaces of adjacent battery cells,
wherein the cooling path extends in one direction of the stacked surfaces of the battery cells, and penetrates in a direction of first ends and second ends of the stacked surfaces of the battery cells.

5. The module of claim 4, further comprising:
a buffer pad coupled between the stacked surfaces of the battery cells,
wherein the buffer pad and the cooling fin are alternately coupled between the stacked surfaces of the battery cells.

6. A battery module assembly comprising:
a battery module comprising a plurality of battery cells stacked in one direction, and a cooling fin coupled between stacked surfaces of the battery cells,
wherein the cooling fin comprises: a cooling plate coupled between the stacked surfaces of the battery cells and in which a cooling path is formed; and a support plate configured to extend from each of upper and lower ends of the cooling plate and cover upper and lower surfaces of adjacent battery cells,
wherein the cooling path is formed to extend in one direction of the stacked surfaces of the battery cells, and penetrates in a direction of first ends and second ends of the stacked surfaces of the battery cells; and
a casing configured to accommodate the battery module,
wherein the casing comprises:
an inlet portion through which a cooling fluid flows into a first side thereof; and
an outlet portion through which a cooling fluid is discharged from a second side thereof.

7. The assembly of claim 6, wherein a movement direction of a cooling fluid from the inlet portion to the outlet portion of the casing and a direction from a first end to a second end of the cooling path of the cooling plate are formed to be parallel.

8. The assembly of claim 6, wherein a space between the inlet portion of the casing and a first end of the battery module accommodated in the casing, and a space between the outlet portion of the casing and a second end of the battery module accommodated in the casing are configured to be filled with the cooling fluid.

9. The assembly of claim 6, further comprising:
a buffer pad coupled between the stacked surfaces of the battery cells,
wherein the buffer pad and the cooling fin are alternately coupled between the stacked surfaces of the battery cells.

10. A cooling fin for a battery module, the cooling fin comprising:
a cooling plate having a rectangular cross-section and including a plurality of cooling paths that are spaced apart from each other; and
a top support plate connected to an upper surface of the cooling plate; and
a bottom support plate connected to a bottom surface of the cooling plate;
wherein the cooling fin has an I-beam shape with the top and bottom support plates providing support for a first and a second battery cell of the battery module and the cooling plate is configured to contact a stacking surface of each of the first and second battery cells, and
wherein the cooling paths are configured to allow a cooling fluid to flow inside the cooling plate for cooling the battery module.
